(19) United States
(12) Patent Application Publication
(10) Pub. No.: US 2011/0063447 A1
(43) Pub. Date: Mar. 17, 2011

(54) VIDEO-IMAGING SYSTEM FOR RADIATION THREAT TRACKING IN REAL-TIME

(75) Inventors: Richard B. VILIM, Sugar Grove, IL (US); Raymond T. Klann, Channahon, IL (US); Peter L. Vilim, Sugar Grove, IL (US)

(73) Assignee: UChicago Argonne, LLC

(21) Appl. No.: 12/881,928

(22) Filed: Sep. 14, 2010

Related U.S. Application Data
(60) Provisional application No. 61/242,700, filed on Sep. 15, 2009.

(51) Int. Cl. H04N 7/18; G09G 5/00

(52) U.S. Cl. 348/159; 345/632

(57) ABSTRACT

A system for overlaying location information of a radiation source onto a current image of an area being monitored. The system is capable of integrating data from various detectors and cameras has been developed to aid in tracking a radiation source. Location information, derived from various detectors, is integrated with near real-time videos of an area being monitored to show clearly where a radiation source is likely located within the area being monitored.

### CROSS REFERENCE TO RELATED PATENT APPLICATIONS

The present application claims priority to U.S. Provisional Patent Application No. 61/242,700, filed Sep. 15, 2009, and the contents of which are incorporated herein by reference in their entirety.

### GOVERNMENT INTEREST

The United States Government has rights in this invention pursuant to Contract No. DE-AC02-06CH11357 between the United States Government and the UChicago Argonne, LLC, representing Argonne National Laboratory.

### FIELD OF THE INVENTION

This invention relates to providing current images of an area being monitored overlaid with location information of a radiation source. More specifically, one embodiment of the invention relates to overlaying location information of a radiation source, based upon data received from detectors, on a current image of an area being monitored from a camera, where the camera and detectors are all mapped onto a single coordinate system.

### BACKGROUND OF THE INVENTION

This section is intended to provide a background or context to the invention that is, inter alia, recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The need for accurate radiation surveillance is expanding as the perceived risk of unsecured nuclear materials entering and transmitting within the country increases. Tracking systems are required to detect, locate, and track a radiation source. Such a system is described in U.S. Pat. No. 7,465,924.

Current systems for detecting and tracking radioactive sources include a live video image of an area that includes the detected radioactive source. Further, current systems determine the most likely location of a radiation source. What current systems lack is the ability of presenting the live video image and the most likely location of the source in a way that an operator can easily determine the actual location of the source within the area being monitored. Current systems allow an operator to see an image of the area being monitored that may contain the most probable location of a source, however, the operator is unable to tell from the video alone where the radiation source is likely located. Collected data from the various detectors and cameras are not integrated together. Because collected data is not combined with image data, current systems require an operator to view data collected from detectors and video images separately from one another. This process must currently be done mentally by the operator. As such, this process is prone to error and the outcome is significantly dependent on the mental acuity of the operator.

Current systems are also limited to using the same type of radiation detectors within a single system. Each detector has a physical connection, means of accessing its data, and data formats. However, detectors of different types have various physical connections, means of accessing data, and data formats. Because of these limitations, current systems are typically built using detectors from the same vendor. This leads to systems that are inflexible in that detectors and cameras of different types are generally unable to be part of the same system. Current systems are also limited in the number of supported detectors and cameras based upon limitations of a system's computer power.

These prior art systems also tend to be limited with respect to configuring the arrangement of detectors and cameras. Generally, the location of the various detectors and cameras must be known to the system. The locations are determined based upon a physical grid manually setup over the area being monitored or calculations specific to the area being monitored. Both of these are time intensive, error prone, and may be impractical given the area being monitored.

Thus, there is a need for a source tracking system which 1) determines the location of the detectors and cameras in the system, independent of the area being monitored, on a single coordinate system, 2) allows the system to use any type of detector and camera, and 3) integrates information regarding the location of a source with image data from the area being monitored. These capabilities need to be provided in a way that maximizes the amount of data that the system can process.

### SUMMARY OF THE INVENTION

The present invention relates to systems and methods for 1) determining the location of the detectors and cameras, independent of the area being monitored, on a single coordinate system, 2) allowing the system to use any type of detector and camera, and 3) integrating collected data regarding the location of a source with image data from the area being monitored. The present invention provides these capabilities while maximizing the amount of data that the system can process. In various embodiments, one or more of the cameras is selectively moveable in order to track a radioactive source moving within the area being monitored. For example, a camera may be configured to tilt and/or pan in response to the movements of the source. Thus, the depiction of the likely location of the source can be substantially maintained at or near the center of a visual display image. In other embodiments, one or more of the cameras is substantially fixed but a moveable electronic visual indicia, for example a crosshair, is generated that tracks a moving radioactive source within the visual display image. In various embodiments, a combination of moveable and fixed cameras may be utilized.

In one embodiment, the present invention relates to a radioactive source tracking system. In this embodiment, the system can include one or more detectors, one or more cameras, unified data collection system, processors, and means of communication for the components of the system. These components could be installed in an area to monitor for radiation sources, to provide near real-time images of the area containing the radiation source, and a graphical overlay of location information on those images.

In another embodiment, location information includes the most probable location of a radiation source within the area being monitored. In another embodiment, the location information is the most probable location of a source, along with the confidence that the source will be located in a region of space surrounding the most probable location. In yet another embodiment, the location information is the probability that a source is located at any given point within the monitored area. Thus, allowing the monitoring of multiple sources contained within the monitored area.

In yet another embodiment, the system includes a number of radiation detectors and a number of cameras. With each detector and camera generating data concerning the current state of the monitored area, the amount of data that requires processing is large. The system must be able to present location information in a timely manner, that is, the information must be timely enough to aid in the locating and recovery of a detected radiation source. To maximize the amount of data processed, the system provides for a unified data collection system for the detectors and cameras.

In still another embodiment, the system includes radiation detectors of various types. The system, therefore, can take advantage of inventories of detectors from of various types. This allows the systems to be easily setup, installed, modified, repaired, and expanded.

These and other objects, advantages, and features of the invention, together with the organization and manner of operation therefore, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flowchart overview of one embodiment of the present invention;

FIG. 2 is a flowchart showing the steps in one embodiment for determining the coordinates of the detectors in a single coordinate system;

FIG. 3 is a flowchart showing the steps in one embodiment for determining the coordinates of the cameras in a single coordinate system;

FIG. 4 is a video imaging system architecture in accordance with the principles of the present invention;

FIG. 5 is a diagram of a single-coordinate system of an area being monitored of one embodiment of the present invention;

FIG. 6 is a diagram of the elements used to determine a camera's location in a single-coordinate system of one embodiment of the present invention;

FIG. 7 is a graph of an exemplary example of possible radiation source locations in the Inter-Detector coordinate system;

FIG. 8 is a graph depicting the location of a source along with confidence levels in accordance with the principles of the present invention;

FIG. 9a is a diagram depicting various elements used to map the location of a source using a substantially fixed camera; FIG. 9b is a diagram of the substantially fixed camera in the coordinate space; and FIG. 9c is a diagram depicting corner points and vectors associated with the field of view (FOV) of the substantially fixed camera; and

FIG. 10 is a diagram depicting the (FOV) of the substantially fixed camera of FIGS. 9a-9c.

### DETAILED DESCRIPTION OF VARIOUS EMBODIMENTS

The present invention relates to providing current images of a monitored area overlaid with location information of a radiation source. In general, the principal components of the present invention are detectors, video cameras, unified data collection, image and video output, and information overlaid on near real time images. In one embodiment, the function capabilities of the present invention include mapping of each detector and each camera onto a single coordinate system, without requiring manually creating a grid on the monitored space. Further capabilities include receiving information from the various detectors, determining location information of a radiation source, and overlaying the location information on a near real-time image of the area being monitored. The near real-time image contains the most probable location of the source within the area being monitored.

In one embodiment, the degree of confidence that the source will be located in a region of space surrounding the most probable location is determined. This confidence is overlaid on the images, containing the most probable location, from any of the system cameras. In another embodiment, the probability of the source being located at any point within the monitored area is calculated. This probability is overlaid on near real-time images from the system cameras.

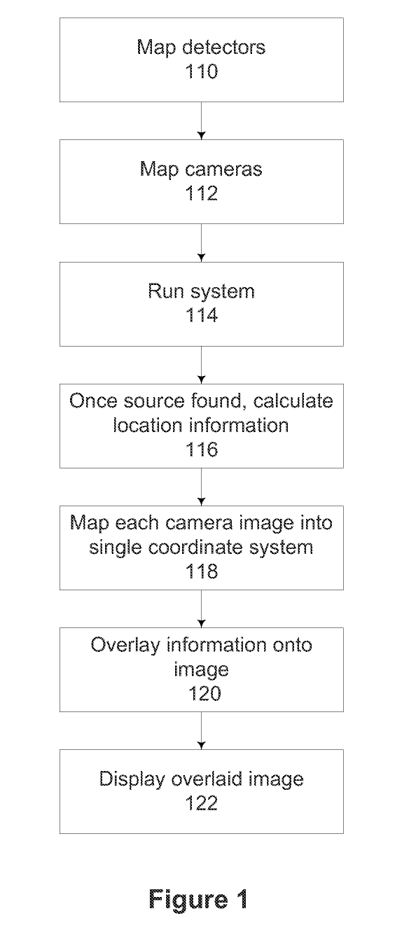

FIG. 1 depicts a flow chart for one embodiment of a process of operation for a device of the present invention. The process begins by determining the coordinates of the detectors in a single coordinate system at step 110. The detectors are setup at points within the monitored area. However, the detectors do not need to be located at specific locations that are related to the area monitored. Instead, the detectors are installed freely at various positions within the monitored space and are then mapped into a single coordinate system. After the detectors are mapped into the single coordinate system, each camera is mapped into the same single coordinate system at step 112. Once the detectors and cameras are installed and mapped into a single coordinate system, the detection system is started at step 114. Various detector systems are well known within the art. One example of a detection system is described in U.S. Pat. No. 7,465,924.

Once the system detects a source, the location information of the source is calculated at step 116. The location information is relative to the single coordinate system. There are various ways of detecting and calculating the location of a radiation source known in the art. Examples include using the Sequential Analysis Test for detection and the Maximum Likelihood algorithms for location as disclosed in U.S. Pat. No. 7,465,924. In one embodiment, the location information contains the most probable location of a source. In another exemplary embodiment, the location information contains the most probable location of a source and the degree of confidence that the source will be located in a region of space surrounding the most probable location. In another exemplary embodiment, the location information includes the probability that a source is located at any given point within the area being monitored. The next step 118 is to map the image from one or more cameras into the single coordinate system. Then the location information is overlaid onto each mapped image at step 120. Finally, the overlaid image is displayed at step 122. In another embodiment, the location information is mapped into the single coordinate system at step 118 of the camera's image. Then the location information is overlaid onto the image of the camera at step 120 and the image is displayed at step 122.

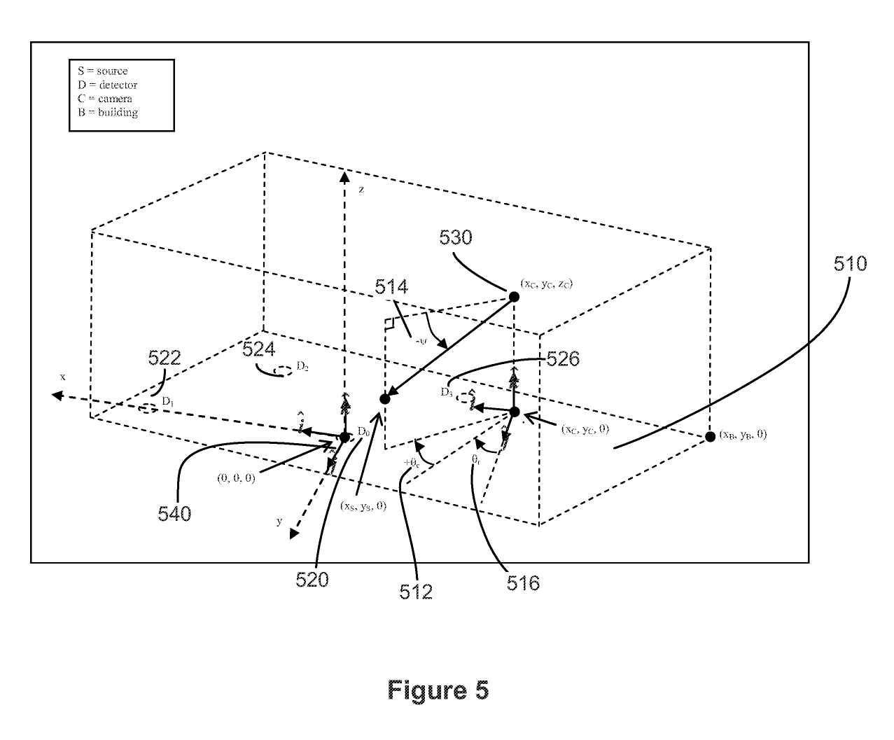

FIG. 5 illustrates one embodiment of a single coordinate system containing a number of detectors and a single camera. The space being monitored 510 contains multiple reference locations 520, 522, 524, 526, and a single camera 530. In one embodiment, the reference locations 520, 522, 524, 526 are mapped onto a single coordinate system using GPS or similar technology. In another embodiment multiple video cameras are installed to capture video data of the area monitored by the multiple detectors and also are mapped into the single coordinate system. In another embodiment of the present invention the reference locations 520, 522, 524, and 526 are mapped into a single coordinate system without requiring GPS information. In such an embodiment, the detectors' location can be calculated as relative to one another in a manner that is independent of the area being monitored 510. Such a coordinate system is referred to as an Inter-Detector coordinate system.

In an Inter-Detector coordinate system it is useful to designate one reference location 520 as the origin of a coordinate system. A second detector is chosen such that the positive x axis pass through the second detector 522. Unit vectors 540 are then defined regarding they and z axes. Note that the orientation of this coordinate system does not depend on any feature of the area being monitored, although in the end features of the area being monitored may be referenced in the single coordinate system if needed. An example would be when the source position is needed to be tied back to Geographic Information System (GIS) coordinates. In this case building GIS coordinates might be a convenient frame of reference for locating the detector coordinate system.

When there are three or more detectors lying in a single horizontal plane, knowledge of the distances between each detector pair provides sufficient information to allow solving for the relative position of each detector. The distance between detectors can be determined using a measuring tape or in an advanced setting obtained in an automated fashion through the use of receiver/transmitter pairs on the detectors. The relative positions solved for are the x and y coordinates of each detector in a Cartesian coordinate system. This coordinate system is aligned such that one reference location 520 lies at the origin and a second detector 522 lies along one of the coordinate axes. The number of unknowns to be solved for is 2m−3 where m is the number of detectors. There is a unique solution when m=3. For m>3, the problem is over determined. The redundancy provides the opportunity to first detect any gross errors in measured inter-detector distances. If none exist, then the redundancy can be used to minimize the effect of routine measurement error on the calculated values of the detector coordinates.

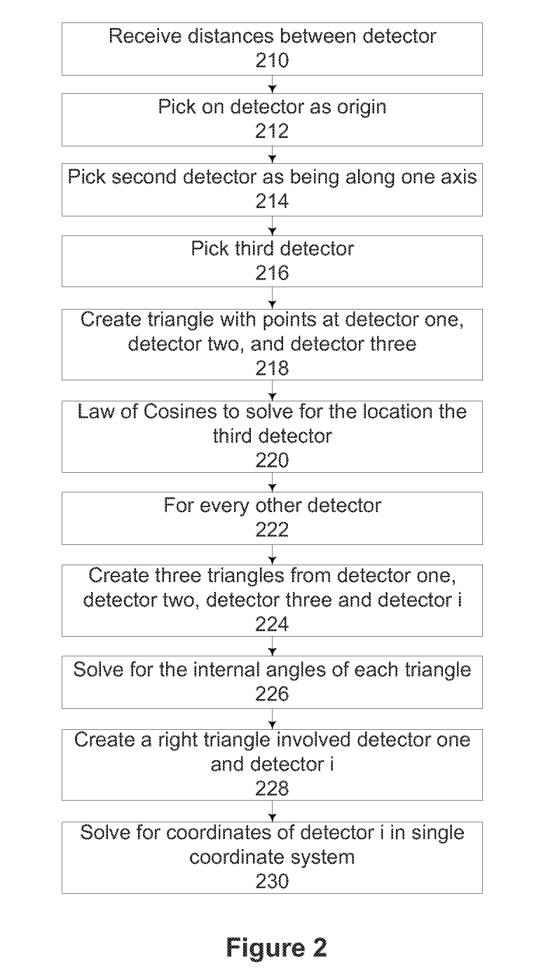

FIG. 2 illustrates one embodiment of the present invention using the Inter-Detector method to determine the coordinates of the radiation detectors. The distances between all of the detectors is received at step 210. In another embodiment, the distances between only 2m−3 detectors is received. Next, an (x, y) coordinate plane is created and the various reference locations, which may be detectors, 520, 522, 524, 526 are arranged on the plane using the measured distances between the detectors 520, 522, 524, 526.
Setting the position of the first detector 520: A single detector is chosen and the coordinates of that detector are set to (0,0) on an x,y coordinate plane at step 212.
Finding the position of second detector 522: A second detector is selected that is a known distance, d₁₂, and the coordinates of that detector is set to (d₁₂,0) on the x,y coordinate plane at step 214.
Finding the position of third detector 526: To find the coordinates of a third detector, a detector is chosen from the remaining unmapped detectors at step 216. The next step 218 creates a triangle whose vertices are the first detector 520, the second detector 522 and the third detector 524. The law of cosines,

p²=a²+b²−2ab cos(P) (1)
is used to find the internal angle, P, of the first detector at step 220. This equation can be algebraically rearranged to

$$P = {cos}^{- 1} ( \frac{{p}^{2} - {a}^{2} - {b}^{2}}{- 2 ab} ) \qquad ( 2 )$$

where P is the interior angle of the first detector, p is the distance from the second detector to the third detector, a is the distance from the first detector to the third detector, and b is the distance from the first detector to the second detector.

To find the position of the third detector in relation to the first detector which is the (0,0) point on our coordinate plane the program or system creates a right triangle using the first and third detectors. The equation

x₃=a cos(P)(3)

describes the relationships of the parts of this triangle where x₃ is the distance on the x axis from detector one to detector three.

The equation

y₃=a sin(P) (4)

describes the relationships of the parts of this triangle where y₃ is the distance on the y axis from detector one to detector three. The position of the third detector on the x,y coordinate plane is therefore (x₃,y₃).

Finding any other detector point: Next, all remaining detector locations are determined at step 222. The process that is used to locate the detectors on the coordinate plane is the same for each detector. Essentially, the following process is used to locate each of the remaining detectors until each detector has been properly located on the single coordinate system. While iterating through the list of remaining unmapped detectors, the current detector for whose location is being solved is known as detector i.

The process starts by creating three different triangles using detectors one, two, three, and i at step 224. It then solves for the interior angle of the first detector in each of these triangles at step 226. The law of cosines is used in calculating this interior angle for the various triangles. For the triangle composed of the first detector, second detector and detector i the equation used is:

p²=a²+b²−ab cos(P₁) (5)

This equation is rearranged to

$${P}_{1} = {cos}^{- 1} ( \frac{{p}^{2} - {a}^{2} - {b}^{2}}{- 2 ab} ) \qquad ( 6 )$$

where P₁ᵢ is the interior angle of the first detector, pᵢ is distance from the second detector to detector i, a is the distance from the first detector to i, and b is the distance from the first detector to the second detector.

For the triangle composed of detectors one, three, and i the law of cosines equation is:

p²=a²+b²−2ab cos(P₂). (7)

This equation can then be rearranged to the following equation.

$${P}_{2} = {cos}^{- 1} ( \frac{{p}^{2} - {a}^{2} - {b}^{2}}{- 2 ab} ) \qquad ( 8 )$$

P₂ᵢ in this equation is the interior angle of the first detector, pᵢ is distance from the third detector to detector i, aᵢ is the distance from the first detector to i, and b is the distance from the first detector to the third detector.

Finally, for the third triangle composed of detectors one, two, and three the law of cosines equation is

p²=a²+b²−2ab cos(P₃). (9)

This equation is then rewritten as

$${P}_{3} = {cos}^{- 1} ( \frac{{p}^{2} - {a}^{2} - {b}^{2}}{- 2 ab} ) , \qquad ( 10 )$$

where P₃ᵢ is the interior angle of the first detector, pᵢ is distance from the second detector to the third detector, aᵢ is the distance from the first detector to the third, and b is the distance from the first detector to the second detector.

The angle P₁ᵢ is the angle that is used to find the location of detector i on the coordinate grid. However, when the position of three points is known and only relational data comparing the points to the fourth point is known, there exists a dual solution. P₁ᵢ can be either negative or positive. Several steps are performed to find the correct value of P₁ᵢ. If

P₁<=P₃+P₂+0.1 and P₁>=P₃+P₂−0.1 (11)

or if

P₁<=P₃−P₂+0.1 and P₁>=P₃−P₂−0.1 (12)

where ξ is an infinitesimal.

### Then P=P₁.

However, if

P₂<=P₁+P₃+0.1 and P₂>=P₁+P₃−0.1 (13)

or if

P₂<=2π−(P₁+P₃+0.1) and P₂>=2π−(P₁+P₃−0.1) (14)

### Then P=−P₁

To find the position of the i detector in relation to the first detector which is the (0,0) point on our coordinate plane, the program or system creates a right triangle using the first, second, and i detectors at step 228. The equation

xᵢ=a cos(P₁) (15)

describes the relationships of the parts of this triangle where x, is the distance on the x axis from detector one to detector i, P₁ᵢ, is the interior angle of detector one in the triangle composed of the first, second, and i detectors, and a, is the distance from the first to the i detector.

The equation

yᵢ=a sin(P₁) (16)

describes the relationships of the parts of this triangle where yᵢ is the distance on the y axis from detector one to detector i, P₁ᵢ is the interior angle of detector one in the triangle composed of the first, second, and i detectors, and aᵢ is the distance from the first to the i detector. The location of the i detector is set equal to (xᵢ,yᵢ) at step 230. The process used to find detector i repeats until the locations of all detectors are known.

The cameras, in order to be effective at monitoring a radiation source which exists in Inter-Detector space, need to be able to find their position in Inter-Detector space. Quite often manual methods of measuring (tape measures, range finders, etc.) will be hard to use or completely unusable because of the location of the camera. An automated method is needed. In order to accurately find the (x,y,z) position of the camera in an Inter-Detector space the (x,y,z) position of three reference locations, each of which may be a detector if elected, needs to be known, the camera pan and tilt must be adjusted, and the tilt and pan of the camera known.

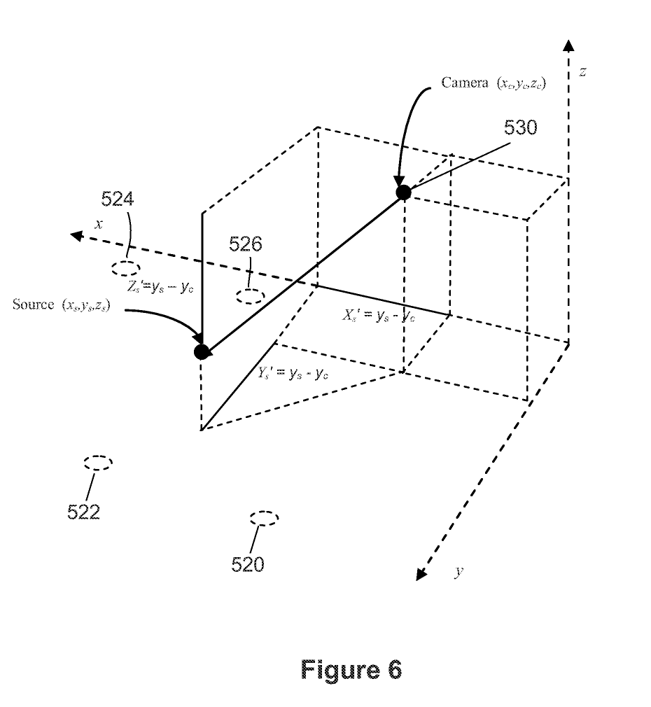

After the locations of at least three reference locations are determined, the location of the cameras within the Inter-Detector coordinate system is determined. FIG. 6 illustrates one example of a camera 530 installed in a space being monitored 510 by four reference locations 520, 522, 524, and 526. The location of the camera within the Inter-Detector coordinate system can now be determined. As shown in FIG. 5, the camera position is referenced with respect to the Inter-Detector coordinate system while its orientation is referenced to the same unit vectors defined at the origin.

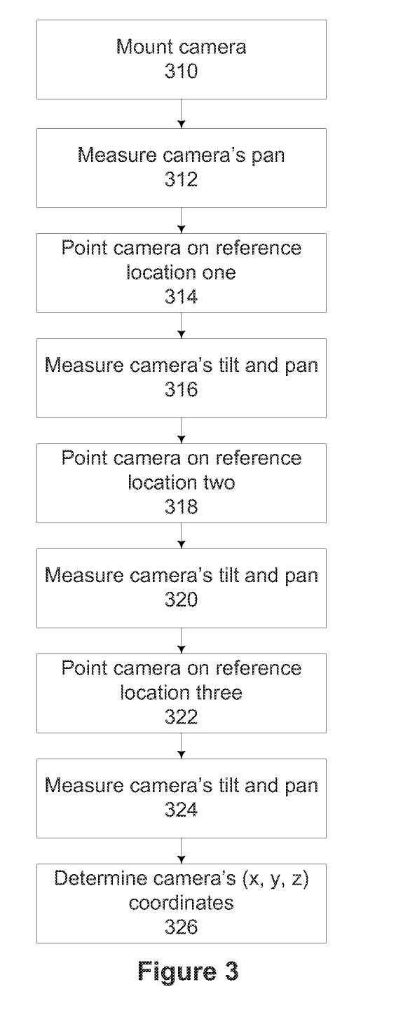

FIG. 3 illustrates one embodiment of the present invention that maps a camera into a single coordinate system without requiring GPS information. First, the camera is mounted to its location at step 310. As part of the mounting process, the initial tilt of the camera is positioned to be parallel to the horizontal plane of the detectors. The pan of the camera base with respect to either axes of the horizontal plane is measured at step 312. The pan orientation of the camera body, θᵣ 516, is defined as the angle between the positive y axis and the axis of the camera body that lies in the horizontal plane. The pan of the camera, θ_{c} 512, is the angle of the camera lens axis to the axis of the camera body that lies in the horizontal plane.

Next, the camera is moved such that the camera points to the reference location 520 at step 314. The state of the camera's tilt and pan is measured at step 316. The camera is then pointed at a second reference location at step 318. After the camera is pointed at the second detector, the camera's tilt and pan is measured at step 320. This process is repeated a third time, by pointing a camera at a third reference location at step 322 and measuring the camera's tilt and pan at step 324.

After measuring the camera's tilt and pan the (x, y, z) coordinates of the camera are determined at step 326. The (x, y, z) position of the camera can be solved with two equations (i being the index representing the detector the camera is currently pointed at). The first equation,

$$sin θ = \frac{{X}_{d - i}^{′}}{\sqrt{{X}_{d - i}^{′2} + {Y}_{d - i}^{′2}}} , \qquad ( 17 )$$

where

θ=θᵣ+θ_{c}

represents the relationship between the camera pan and reference location i. FIG. 6 defines X_{d-I}′ and Y_{d-I}′. This can be expanded to give

sin(θᵣ+θ_{c})\sqrt{(x_{d-i}−x_{c})²+(y_{d-i}−y_{c})²}=(x_{d-i}−x_{c}) (18)

where θᵣ 516 is the angle from the reference venue to the camera zero pan angle as previously defined, θ_{c} 512 is the camera's pan angle, x_{d-i}, is the x axis value of the reference location i, x_{c} is the x coordinate of the camera, y_{d-i}, is they axis value of the reference location referenced by index i, and y_{c} is they coordinate of the camera. The second equation,

$$sin ψ = \frac{{Z}_{d - i}}{\sqrt{{( \sqrt{{Y}_{d - i}^{2} + {X}_{d - i}^{2}} )}^{2} + {Z}_{d - i}^{′2}}} \qquad ( 19 )$$

where Z_{d-I}′ is defined in FIG. 6 represents the relationship between the camera tilt and reference location i. This can be expanded to give

$$sin ψ = \frac{{z}_{d - i} - {z}_{c}}{\sqrt{{( {y}_{d - i} - {y}_{c} )}^{2} + {( {x}_{d - i} - {x}_{c} )}^{2} + {( {z}_{d - i} - {z}_{c} )}^{2}}} \qquad ( 20 )$$

where ψ 514 is the tilt angle of the camera, x_{d-i}, is the x axis value of the reference location referenced by index i, y_{d-i}, is the y axis value of the reference location referenced by index i, z_{d-i} is the z axis value of the reference location referenced by index i, x_{c} is the x coordinate of the camera, y_{c} is they coordinate of the camera, and z_{c} is the z coordinate of the camera.

To find the x,y,z of the camera, each of the pan and tilt measurements from when the camera was pointing at the three separate reference locations are used. Equations (18) and (20) are applicable to each location and result in six non-linear equations (Eqs. (18) and (20) for each location) and four unknowns (x_{c},y_{c},z_{c},θᵣ). The unknowns can be solved for by attempting all possible values of x, y, z, and θᵣ in a venue-bound range. Whichever iteration results in an answer closest to zero is the correct iteration, and that set of x, y, and z values for the camera position is the position of the camera.

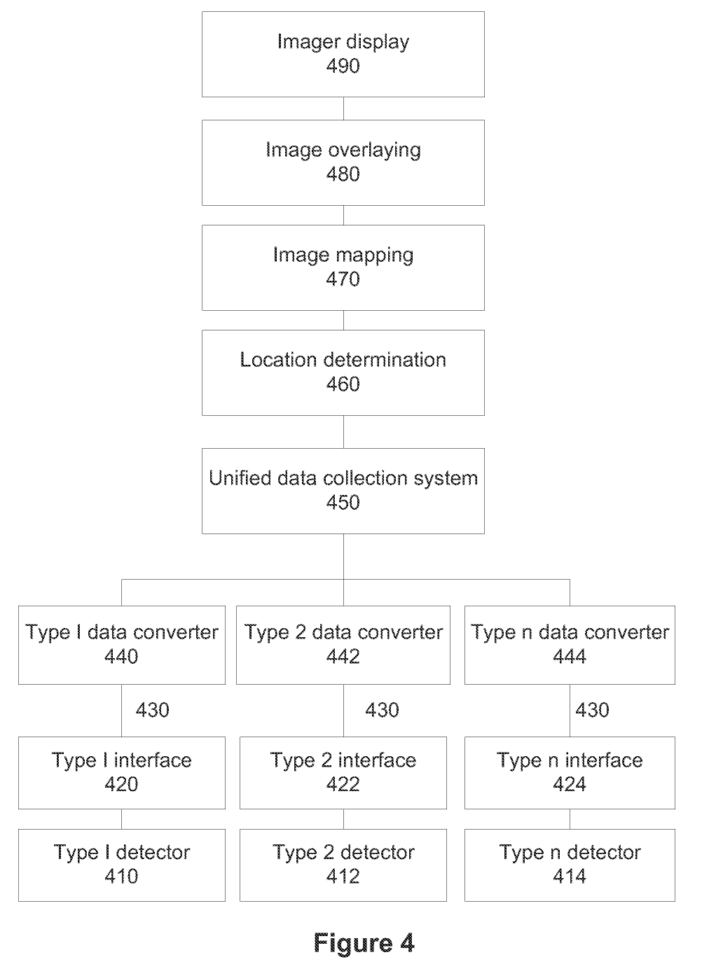

FIG. 4 depicts one embodiment of the present invention. The illustrated system provides a unified data collection interface for the collecting and accessing of data from a number of devices some of which do not share the same physical connection types, the same protocols, or the same data formats. To unify the collection of data from these devices, the devices must be connected to the system, access to the devices' data must be allowed, and the data must be converted into a standard format.

The unified data collection interface 450 collects data from various detectors 410, 412, and 414. In another embodiment the unified data collection interface 450 collects data from video cameras instead of detectors. In yet another embodiment the unified data collection interface 450 collects data from both radiation detectors and video cameras. Interfaces 420, 422, 424 are used to physically interface with each detector. In one embodiment of the system, the devices use USB or serial cables to connect with the interfaces. The interfaces are also coupled to the unified data collection interface 450. The interfaces are therefore used to physically connect the detectors with the system. In one embodiment, the interfaces use Ethernet to connect with the unified data collection system 450.

Allowing access to the data contained within the devices require that the system be able to communicate with the devices. Specifically, this requires that the system be able to address each detector and camera separately. This is accomplished by using a communication protocol 430 that encapsulates the protocols of the various detectors. In one embodiment TCP/IP is used as the communication protocol for the Ethernet network.

To provide access to unified data from various detectors, the data must be converted into a standard detector format. This is accomplished by using data converters 440, 442, 444. These data converters take output data of a specific format and convert the data to the standard detector format. In one embodiment, to maximize the amount of data that can be processed in real-time, each data converter is implemented in software. Specifically, each converter is implemented in its own thread in a multi-threaded process. This allows the data processing to be done in parallel. One skilled in the art would recognize that the converters could be spread across multiple processors in order to process more data. This standardized data is then made available to the location determination component 460.

The location information of a radiation source is then determined based upon the standardized data. Once a radiation source is located, current images from the cameras are mapped into the single coordinate system in the image mapping component 470. Finally, the location information of a radiation source is overlaid on the mapped current images in the image overlaying component 480 and the images are displayed 490.

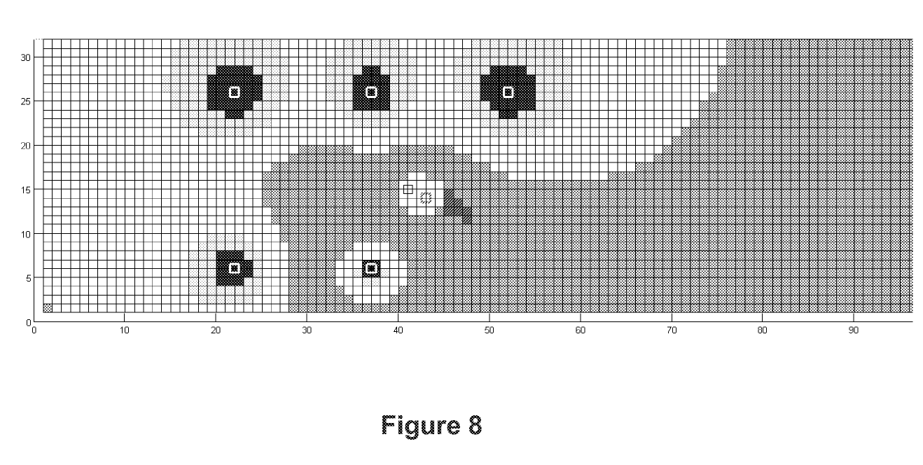

FIG. 8 is a graphical depiction of the likelihood contour of a source located within an area being monitored by five detectors. Methods of determining the likelihood contour are well known within the art. One such example is using the Multiple Detector Probability Density Function as described in U.S. Pat. No. 7,465,924.

Given an (x,y) coordinate of a radiation source within the Inter-Detector space, a camera can automatically provide an image of that area. This is done by determining the necessary pan and tilt required of the camera to locate the radiation source. The necessary pan and tilt to center the camera on the source can be solved as follows. The position of the source relative to the camera can be found by solving

Xₛ′=xₛ−x_{c}

Yₛ′=yₛ−y_{c}

Zₛ′=zₛ−z_{c} (21)

The combined pan angle of the camera and angle from the reference venue can be solved by

$$θ = {sin}^{- 1} \frac{{X}_{s}^{′}}{\sqrt{{X}_{s}^{′2} + {Y}_{s}^{′2}}} \qquad ( 22 )$$

in which θ is the combined pan angle of the camera and angle from the reference venue, Xₛ′ is the x distance between the camera and source, and Yₛ′ is the y distance between the camera and source.

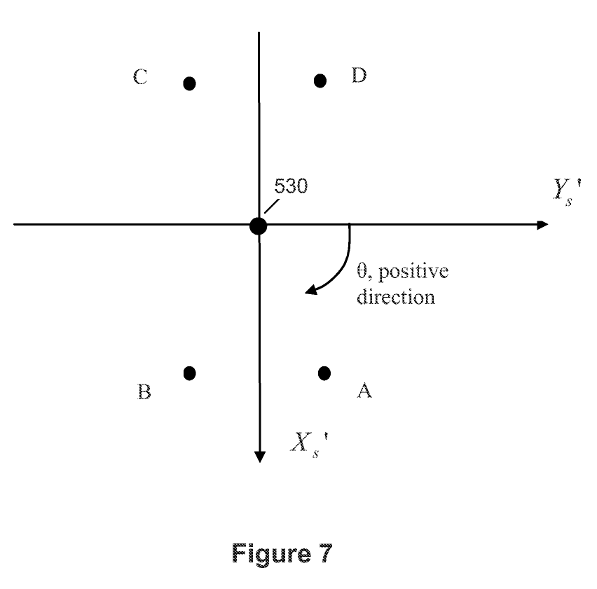

The presence of the inverse sine function in the above expression requires special attention. For a given value of the inverse sine function there can be two angles that correspond to this value. A logic test is needed to select the appropriate angle. The selection is based on the sign of Xₛ′ and of Yₛ′. The approach is to locate the source to within one of four quadrants. Within that quadrant there is a unique relationship between the inverse sine and the angle θ. It is useful to consider the problem in terms of FIG. 7. In FIG. 7, the camera is assumed to be at the origin. Four possible source locations are marked with the letters A, B, C, and D. The absolute value of Xₛ′ and of Yₛ′ are the same for all of these points. As seen in the figure there are four cases with respect to the signs of Xₛ′ and Yₛ′. The angle θ for each of these points is given below in terms of the equation below

$$angle = sin \frac{\vert {X}_{s}^{′} \vert}{\sqrt{{X}_{s}^{′2} + {Y}_{s}^{′2}}} . \qquad ( 23 )$$

For the four points:

A: Xₛ′>0 and Yₛ′>0=>0<θ<90=>θ=angle

B: Xₛ′>0 and Yₛ′<0=>90<θ<180=>θ=180−angle

C: Xₛ′<0 and Yₛ′<0=>180 <θ<270=>θ=angle−180

D: Xₛ′<0 and Yₛ′>0=>−90<θ<0=>θ=−angle

Now that the combined angle has been uniquely identified for the pan angle necessary to center the camera on the source computed from the camera pan angle is

θ_{c}θ−θᵣ (24)

where θᵣ is the angle from the reference venue to the camera zero pan angle, θ_{c} is the camera's pan angle, and θ is these two angles combined.

The necessary tilt angle to center the camera on the source is given by

$$ψ = {sin}^{- 1} \frac{{Z}_{s}^{′}}{\sqrt{{X}_{s}^{′2} + {Y}_{s}^{′2} + {Z}_{s}^{2}}} \qquad ( 25 )$$

in which ψ is the camera's pan angle, Xₛ′ is the x distance between the camera and source, Yₛ′ is the y distance between the camera and source, and Zₛ′ is the z distance between the camera and source.

In various embodiments, one or more of the cameras may be configured to selectively move by panning and/or tilting the camera to track the movement of the radioactive source. As the camera moves, its position is updated as described above. The movement of the camera may be automated such that camera tracks the movements of the radioactive source based on the determination of the most likely location of the source. As such, the video display image is updated in near real-time to track the source and most likely location of the source is continuously depicted substantially near the center of the video image as the camera moves accordingly.

In another exemplary embodiment, the coordinates of the image are transformed into the single coordinate system. The location information is then mapped onto the image, without transforming the location information.

In still other embodiments, one or more of the cameras is substantially fixed such that the camera is not configured to automatically move to track a moving radioactive source. A number of substantially fixed cameras may be utilized, each of which may cover selected portions of an area being monitored. Additionally, a combination of selectively moveable and substantially fixed cameras may be utilized in various embodiments. When a substantially fixed camera is utilized a visual indicia is generated and depicted with the video display image. The visual indicia is electronically generated and may include a crosshair, point, circle, rectangle, coloration or other reticle that indicates the determined most likely position of the radioactive source.

In a preferred embodiment utilizing a fixed camera, the source position is mapped onto the video display image even if the camera is not pointing directly at the source. The source location with respect to a coordinate system, for example a building space coordinate system, is mapped to one or more corresponding pixels of the video display image to visually indicate the most likely location of the radioactive source. The source position mapping is updated so that the depicted location of the source moves about the video display image in near real-time in response to movement of the radioactive source.

The mapping process may be accomplished by defining an infinite plane that both contains the radioactive source and is parallel to the camera imaging plane. The camera location is given by \vec{c}=(x_{c},y_{c},z_{c}) and the source location by \vec{a}=(xₛ,yₛ,zₛ). A line L normal to the plane runs from \vec{c} to a point \vec{b} in the plane. L is decomposed into its vector components Lₓ, L_{y}, L_{z} which are given by

Lₓ=L cos(ψ)sin(θᵣ+θ_{c}) (27a)

L_{y}=L cos(ψ)cos(θᵣ+θ_{c}) (27b)

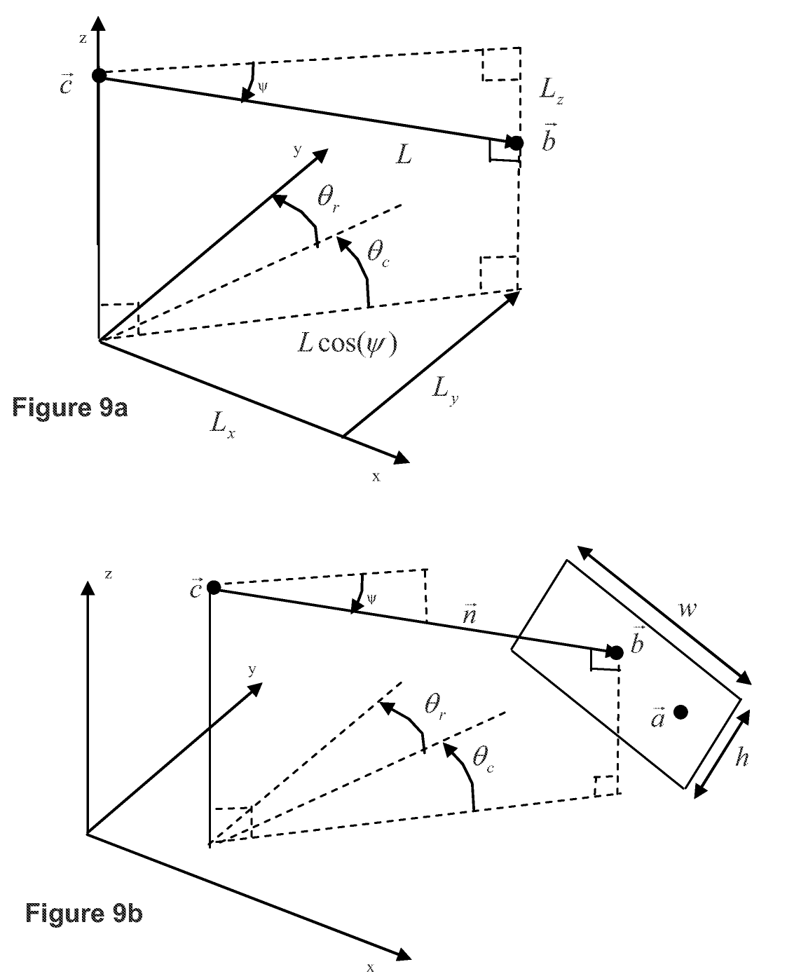

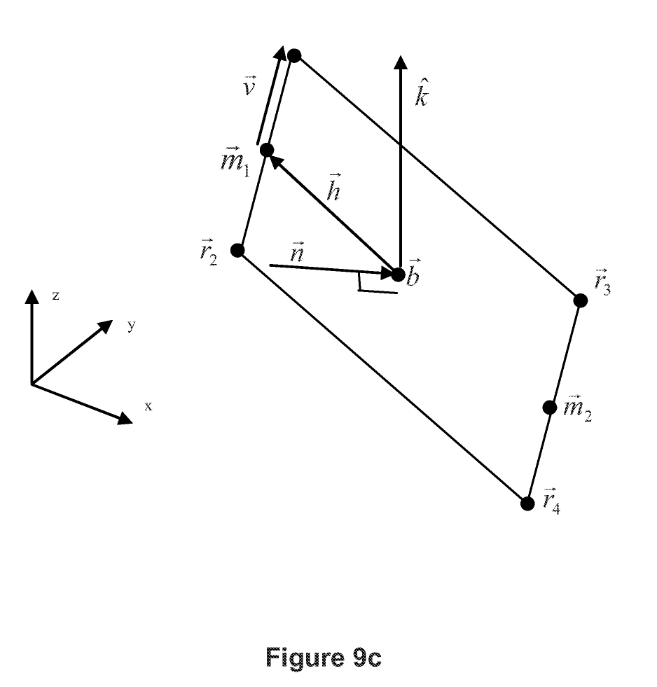

L_{z}=L sin(ψ) (27c)

where θᵣ is the camera's reference pan computed when the camera was set up, θ_{c} is the camera's internal pan, ψ is the camera's internal tilt. FIG. 9a depicts the various components of the line L.

From these components, a unit vector \vec{n} shown in FIG. 9b is computed that points out from, or “straight ahead of,” the camera and along L

$$\vec{n} = [ \begin{matrix}cos ( ψ ) sin ( {θ}_{r} + {θ}_{c} ) \\ cos ( ψ ) cos ( {θ}_{r} + {θ}_{c} ) \\ sin ( ψ )\end{matrix} ] . \qquad ( 28 )$$

This vector is normal to the camera imaging plane. The infinite plane that is normal to this vector and intersects the source position is given by

$$\vec{n} \cdot [ \begin{matrix}x - {x}_{s} \\ y - {y}_{s} \\ z - {z}_{s}\end{matrix} ] = 0 \qquad ( 29 )$$

which simplifies to

cos(ψ)sin(θᵣ+θ_{c})(x−xₛ)+cos(ψ)cos(θᵣ+θ_{c})(y−yₛ)+sin(ψ)(z−zₛ)=0 (30)

It is necessary to determine the point \vec{b} at which the line \vec{n}t+\vec{c} intersects the plane in Equation 29 where t is a scale factor determining length. To determine the value of t corresponding to the point along the line \vec{n}t+\vec{c} that intersects the plane, the coordinates for the line are substituted into Equation 29 to obtain

$$t = - \frac{\begin{matrix}cos ( ψ ) sin ( {θ}_{r} + {θ}_{c} ) ( {c}_{x} - {x}_{s} ) + \\ cos ( ψ ) cos ( {θ}_{r} + {θ}_{c} ) ( {c}_{y} - {y}_{s} ) + sin ( ψ ) ( {c}_{z} - {z}_{s} )\end{matrix}}{\begin{matrix}{n}_{x} ( cos ( ψ ) sin ( {θ}_{r} + {θ}_{c} ) ) + \\ {n}_{y} ( cos ( ψ ) cos ( {θ}_{r} + {θ}_{c} ) ) + {n}_{z} ( sin ( ψ ) )\end{matrix}} \qquad ( 31 )$$

The value of t substituted back into the line yields the point \vec{b}=\vec{n}t+\vec{c}. A depiction of the camera in relation to the coordinate system and the source is illustrated in FIG. 9b.

The field of the camera is also determined. Only a certain portion of the plane lies in the camera's field of view (FOV) rectangle. To find the four corners of the camera's field of view that lie on the plane defined by Equation 29 it is necessary to know the relation between the camera's zoom value, the distance between the camera and the plane, and the size of the field of view rectangle. At 0× magnification, w=r(v_{w}/c_{d}), where w is the width of the FOV rectangle, r is the distance from the camera to the plane, v_{w} is the width of the camera's viewable area at a particular distance to a surface, c_{d},

w=|\vec{c}−\vec{b}|(v_{w}/c_{d}). (32)

For example, for a particular camera, w=r(v_{w}/c_{d})=r( 88/92). The fraction 88/92 was arrived at by experiment. The camera was placed 92 inches away from a surface and the corners of the camera's viewable area were marked on the surface. The width of this area was 88 inches. Using these two pieces of information the width of the FOV rectangle can be determined by knowing the distance from the camera to the FOV plane as given by Equation 32. It will be appreciated that the fraction may be different for other cameras.

Under variable magnification,

$$w = \vert \vec{c} - \vec{b} \vert \frac{( {v}_{w} / {c}_{d} )}{s} \qquad ( 33 )$$

where s is the magnification level of the camera. By way of example, for a particular camera s varies between 0× and 35× magnification but it will be appreciated that cameras of different magnification levels may be used.

The aspect ratio for the camera is also determined, which is determined by the pixel aspect ratio of the camera, where pxₕ is the number of pixels along the horizontal axis of the camera and pxᵥ is the number of pixels along the vertical axis of the camera. This means that

$$h = w \frac{{px}_{h}}{{px}_{v}} \qquad ( 34 )$$

where h is the upright-edge length of the FOV rectangle. For example, for a particular camera, the aspect ratio of the camera is 1.47:1, 704×480 (704/480=1.47:1 aspect ratio), which is specified by the manufacturer, and h=w(1/1.47). Again, it is contemplated that cameras of different aspect ratios may be utilized. Then, as shown in FIG. 9c, two points on the outside edges of the FOV rectangle at the midpoint of the rectangle edges are found. First,

\vec{h}=\hat{k}×\vec{n} (35)

is defined, where \hat{k} is the upward pointing unit vector, and \vec{h} is parallel to the lower edge of the FOV or, equivalently, the ground assuming the ground is not inclined. Using \vec{h} the two midpoints are found by

$$\begin{matrix}\vec{m} = \vec{b} \pm ( \vec{h} / \vert \vec{h} \vert ) \frac{w}{2} , & ( 36 ) \\ or & \\ {\vec{m}}_{1} = \vec{b} + ( \vec{h} / \vert \vec{h} \vert ) \frac{w}{2} and {\vec{m}}_{2} = \vec{b} - ( \vec{h} / \vert \vec{h} \vert ) \frac{w}{2} . & ( 37 )\end{matrix}$$

Then, another vector is constructed

$$\vec{v} = ( \frac{( \vec{n} \times \vec{h} )}{\vert \vec{n} \times \vec{h} \vert} ) \frac{h}{2} \qquad ( 38 )$$

where \vec{v} is a vector of a length h/2 and parallel to the upwards edges of the FOV rectangle. Corner points can then be found by

\vec{r}ₐ=\vec{m}₁±\vec{v} and \vec{r}_{b}=\vec{m}₂±\vec{v}, or in expanded form (39)

\vec{r}₁=\vec{m}₁+\vec{v}, (39a)

\vec{r}₂=\vec{m}₁−\vec{v}, (39b)

\vec{r}₃=\vec{m}₂+\vec{v}, and (39c)

\vec{r}₄=\vec{m}₂−\vec{v}, (39d)

Once the location of the source on the plane and the corners of the plane are determined the location of the source can be determined and scaled to appear at the correct position on the visual display image. This is best understood by a view looking directly at the FOV rectangle which corresponds to the display screen a user views. Before the display coordinates are calculated though it is necessary to determine if the source position is in the FOV rectangle. The source position is not above or below the FOV rectangle if

a_{z}≧r_{2z},a_{z}≧r_{4z},a_{z}≦r_{1z}, and a_{z}≦r_{3z} (40)

are all true. A vector \vec{z} travels from the upper left hand corner to the source location \vec{a} and is given by \vec{z}=\vec{a}−\vec{r}₁. A line of length x_{fov} is projected on to a line running from \vec{r}₁ to \vec{r}₃ or \vec{r}₃−\vec{r}₁. The projection is given by

$$\begin{matrix}{x}_{fov} = \vec{z} \cdot ( \frac{( {\vec{r}}_{3} - {\vec{r}}_{1} )}{\vert {\vec{r}}_{3} - {\vec{r}}_{1} \vert} ) . & ( 41 ) \\ If & \\ {x}_{fov} \geq 0 and \frac{{x}_{fov}}{\vert {\vec{r}}_{3} - {\vec{r}}_{1} \vert} \leq 1 & ( 42 )\end{matrix}$$

are both true then the source lies in the FOV rectangle.

The magnitude x_{fov}, gives the x location of detector on the user's screen after it is scaled to match the pixel density of the screen. In a particular embodiment,

$$x = {x}_{fov} * \frac{{px}_{h}}{\vert {\vec{r}}_{3} - {\vec{r}}_{1} \vert} \qquad ( 43 )$$

will produce the x coordinate in pixels of the source on the user's screen with the scale factor being

$$\frac{{px}_{h}}{\vert {\vec{r}}_{3} - {\vec{r}}_{1} \vert} ,$$

and in the particular camera example described above where the user's screen is 704 pixels wide pₓₕ=740. To find the y coordinate on the FOV rectangle the FOV rectangle is used

|\vec{y}|=\sqrt{|\vec{z}|²−x_{fov}²} (44)

and the result is scaled to match the display screen so that in pixels

$$y = \vert \vec{y} \vert * \frac{{px}_{v}}{\vert {\vec{r}}_{1} - {\vec{r}}_{2} \vert} . \qquad ( 20 )$$

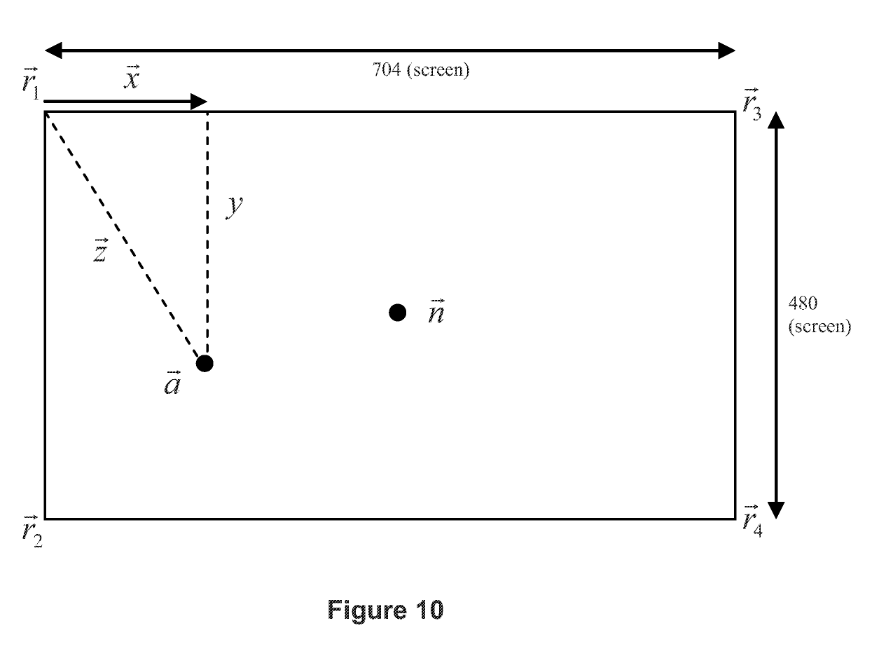

The 0,0 coordinate for this x,y will be the upper left hand corner of the screen. FIG. 10 illustrates the FOV rectangle with x,y screen coordinates.

The foregoing description of embodiments of the present invention have been presented for purposes of illustration and description. It is not intended to be exhaustive or to limit the present invention to the precise form disclosed, and modification and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A system for overlaying location information of a radiation source on a near real time image, comprising:
at least one radiation detector mapped onto a unified coordinate system for capturing radiation information associated with the radiation source;
at least one video camera mapped onto the unified coordinate system configured to capture video data;
a unified data collection system in communication with the at least one radiation detector and the at least one video camera, the unified collection system including a storage portion configured to store the radiation information and the video data;
a location information architecture configured to process the radiation information into location information of the radiation source; and
an image overlay architecture configured to overlay the location information onto the video data from the at least one video camera.

2. The system of claim 1, wherein the at least one radiation detector comprises a plurality of radiation detectors of various types, and wherein data from each type of detector is in a different format.

3. The system of claim 1, wherein the at least one video camera comprises a plurality of video cameras.

4. The system of claim 3, wherein the plurality of video cameras includes at least one substantially fixed video camera, and wherein the overlaid location information associated with the substantially fixed video camera is moveable in relation to the video data in response to movement of the radiation source.

5. The system of claim 3, wherein the plurality of video cameras includes at least one moveable video camera selectively moveable in at least a first direction and a second direction in response to movement of the radiation source, and wherein the location information is depicted at a substantially fixed predetermined location within a composite image comprising the video data and the location information.

6. The system of claim 1, wherein the location information of the radiation source further includes the confidence that the radiation source will be located in a region of space surrounding the most probable location.

7. The system of claim 1, wherein the location information of the radiation source is a probability that the radiation source is located within any point of the unified coordinate system.

8. A method for receiving radiation location information of a radiation source and receiving near real time video image data and overlaying the location information of a radiation source on the near real time video image data, comprising:
mapping at least one radiation detector onto a unified coordinate system;
mapping at least one video camera onto the unified coordinate system, the at least one video camera acquiring video camera images of an area;
detecting the radiation source with the at least one radiation detector;
determining the location information of the radiation source;
mapping the video camera image from at least one of the video cameras and the location information into a coordinate system; and
overlaying the location information of the radiation source onto at least one of the video camera images.

9. The method of claim 8, wherein mapping the at least one video camera images and the location information into the coordinate system comprises:
mapping the at least one video camera images into the unified coordinate system.

10. The method of claim 8, wherein mapping the at least one video camera images and the location information into the coordinate system comprises:
mapping the location information into a coordinate system of the at least one video camera images.

11. The method of claim 8, wherein the location information includes a most probable location of the radiation source.

12. The method of claim 11, wherein the location information further includes the confidence that the radiation source is located in an area surrounding the most the most probable location of the radiation source.

13. The method of claim 8, wherein the location information includes the probability that the radiation source is located within any point of the unified coordinate system.

14. A method for forming a composite video image depicting the location of a radiation source, comprising:
determining the location of one or more radiation detectors and one or more video cameras in a unified coordinate system;
receiving information from the one or more radiation detectors;
determining the location information of the radiation source;
receiving video information from the one or more video cameras;
mapping the video information and the location information into a coordinate system; and
overlaying the location information of the radiation source onto the video information to form a composite video image,
wherein the composite video image is indicative of the location of the radiation source.

15. The method of claim 14, wherein mapping the video information and the location information into the coordinate system comprises:
mapping the one or more video cameras images into the unified coordinate system.

16. The method of claim 14, wherein mapping the video information and the location information into the coordinate system comprises:
mapping the location information into a coordinate system of the one or more cameras.

17. The method of claim 14, wherein the location information includes a most probable location of the radiation source and the confidence that the radiation source is located in an area surrounding the most the most probable location of the radiation source.

18. The method of claim 14, wherein at least one of the one or more video cameras comprises a substantially fixed video camera, and wherein overlaying the locating information from the substantially fixed video camera includes moving the location information in relation to the video information in response to movement of the radiation source.

19. The method of claim 14, wherein at least one of the one or more video cameras comprises a moveable video camera selectively moveable in response to movement of the radiation source, and wherein the position of the location information is substantially maintained within the composite video image.

20. The method of claim 14, wherein the location information includes the probability that the radiation source is located within any point of the unified coordinate system.
